(19) United States
(12) Patent Application Publication
(10) Pub. No.: US 2002/0152379 A1
(43) Pub. Date: Oct. 17, 2002

(54) Method, arrangement and device for voting

(76) Inventors: Boris Gefwert, Espoo (FI); Toni Nummi, Helsinki (FI)

Correspondence Address: YOUNG & THOMPSON, 745 SOUTH 23RD STREET 2ND FLOOR, ARLINGTON, VA, 22202

(21) Appl. No.: 10/119,020

(22) Filed: Apr. 10, 2002

(30) Foreign Application Priority Data
Apr. 11, 2001 (FI) 20010761

(51) Int. Cl. H04L 9/00

(52) U.S. Cl. 713/168

(57) ABSTRACT

The invention relates to a method and arrangement for voting. In particular the invention relates to voting by means of a terminal. In a voting method according to the invention, the eligibility of the voter is verified in the register of eligible voters, and an encrypted polling code is generated from the candidate information of the candidate selected, based on the public key method. The resulting encrypted polling code is sent to the election data system where the polling code is decrypted and the vote contained in the polling result is recorded to the respective candidate.

The invention relates to a method and arrangement for voting. In particular the invention relates to voting by means of a terminal.

Voting is one of the fundamental rights in a democratic society and thereby it has been ensured that each member of a community can take part in the decision-making. Among the central principles related to voting and electoral system, also included in law, are for example the secrecy of the ballot and universal suffrage. In elections it is important to ensure that the voters' rights are not violated and the votes are accurately tallied and each vote is processed correctly.

The current voting method is based on a system in which voters may vote either in advance at certain early polling sites or on the election day proper at their respective polling stations. Voting takes place in a supervised location where the voters are identified, their right to vote is verified, they enter a polling booth and select a candidate's number. The voter writes, in plain hand-writing, the candidate's number on the ballot paper and then takes the ballot to an election official who stamps the ballot, after which the voter drops the ballot in the ballot box. When the voting comes to an end, all ballots are counted at the polling stations and the numbers written on the ballot papers are tabulated to the respective candidates. The ballots and candidates' votes are typically counted by hand.

There are, however, some disadvantages related to the arrangements according to the prior art. If often happens that the numbers or letters written by the voters op the ballot papers are hard to read so that when the votes are counted there may occur great problems of interpretation or, in the worst case, the vote cannot be tallied at all. Second, the large number of ballot papers means that accurate tallying is cumbersome and slow, sometimes even impossible. Moreover, the interpretation difficulties and other human errors undermine the reliability of the system. Furthermore, in a sparsely populated country like Finland, for example, the costs of elections will easily become unreasonable in proportion to the number of voters, as a result of the need to set up polling stations and hire election officials. In addition, the provision of an opportunity of absentee voting for people in institutions such as hospitals or prisons or other such places as well as for seamen at sea, as decreed by law, is difficult and in some cases even impossible by means of the current arrangements. Finally, in small communities, the secrecy of the ballot may easily be compromised.

Attempts have been made to introduce voting methods that would reduce the aforementioned disadvantages, and one such method is voting over the Internet, which, indeed, is often a simple and quick method e.g. in opinion polls where security issues are not crucial. Currently, however, the Internet is not applicable to, say, national or local elections because Internet voting cannot guarantee the statutory election principles such as election freedom, for example. Furthermore, Internet voting cannot at present guarantee a complete secrecy of the ballot because the voters must be authenticated and their polling codes recorded at the same time but, on the other hand, it should not be possible to tie an individual voter to the contents of his ballot.

An object of the invention is to provide a voting system in which voting can be done easily, flexibly, securely and quickly at reasonable cost and adhering to the secrecy of the ballot and election freedom independent of the polling place, its size, and election officials. Another object of the invention is that the number or some other piece of information of the candidate selected by the voter can be interpreted and the votes given to the individual candidates can be counted unambiguously, reliably and, if necessary, in real time. The objects of the invention are achieved by an arrangement in which the voter at a polling station enters the candidate information of his selected candidate at a terminal which generates an encrypted polling code which can be unequivocally associated with the candidate in question and which is transmitted to the election data system.

A voting method according to the invention is characterized in that the method comprises steps in which

an encrypted polling code is generated from the candidate information of the candidate selected by the voter,

the voter's encrypted polling code is transmitted to the election data system,

the encrypted polling code is decrypted in the election data system, and

the vote contained in the polling code is recorded to the respective candidate.

A voting arrangement according to the invention, in which the voter selects a candidate based on candidate information associated with the candidate, is characterized in that the arrangement comprises a register of eligible voters and an election data system as well as

a means for generating an encrypted polling code from the candidate information of the candidate selected by the voter,

a means for transmitting the voter's encrypted polling code to the election data system,

a means for decrypting the encrypted polling code in the election data system, and

a means for recording the vote contained in the polling code to the respective candidate.

Some advantageous embodiments of the invention are presented in the dependent claims.

The invention brings significant advantages compared to the current voting methods. A method according to the invention enables a quick, easy, reliable and location-independent way of voting either in advance or, legislation permitting, also on the election day proper. When voting, the voter does not necessarily need to write the number or name of the selected candidate on paper, but an encrypted polling code, which corresponds to the selected candidate, can be printed out on paper by means of a printer which is placed in the polling booth and is connected to a terminal. All the voter needs to do is select a candidate e.g. from a list attached to the wall of the booth, or direct from a display screen.

In addition, a method according to the invention guarantees the secrecy of the ballot as well as election freedom also in small communities or even in institutions such as hospitals and prisons. A method according to the invention eliminates the possibility of uncertainties on the ballot paper, so the polling code can be recorded quickly and unambiguously to the selected candidate. Using a method according to the invention, the cumulative number of votes cast for a candidate can even be observed in real time, if necessary.

Moreover, a method according to the invention enables a polling station to be set up very quickly and virtually at any place so that the setting-up costs of a polling station can be kept very low. In accordance with a method according to the invention the polling station may be e.g. a mobile means such as a traveling library, postal bus or some other similar vehicle. This is especially advantageous in, say, sparsely populated areas, so that at election time a so-called voting vehicle could roam such areas, carrying with it the necessary equipment for voting in compliance with a voting method according to the invention.

The invention can be used in voting for candidates in local and national elections. The invention can also be used in voting in an opinion poll in which the voters express their preference for or against an issue such as e.g. nuclear power or some other issue where the voters choose from different alternatives.

Some terms used in this patent application are defined below:

“Candidate”: a person as a candidate in an election, or an option in an issue e.g. in an opinion poll, such as a poll about nuclear power, for instance.

“Candidate information”: a number or some other piece of information associated with a candidate, displayed e.g. on a list on a wall of a polling booth and/or on the display screen of a terminal for the purpose of identification of and voting for the individual candidates. In an opinion poll, the candidate information may be e.g. “Yes” or “No” or, if numbers are used, “1” or “0”.

“Terminal”: an apparatus, such as e.g. a mobile communication device, at the disposal of an election official to verify the eligibility of the voter from the register of eligible voters, to transmit the polling code to the election data system, and to utilize the technology made possible by digital signatures.

“Encryption method”: any known process in which the ballot cast by the voter can be encrypted such that the ballot can be decrypted only in the election data system using an appropriate encryption key.

“Random code”: any arbitrary sequence of symbols, comprised of numbers, letters and/or special characters.

“Election data system”: a system to which the votes are sent and in which the votes for the individual candidates are recorded and tabulated. An election data system may also include a register of eligible voters.

“Election official”: an authorized person supervising the polling at the polling station, who also acts as electoral aide, if required.

“Polling code”: a ciphered code generated, by means of an encryption method, from the candidate information of the candidate selected by the voter and a random code associated with the candidate information and a possible check symbol, where the ciphered code can be deciphered only in the election data system with an appropriate cipher key, and where the result of the deciphering unequivocally reveals the candidate voted by the voter.

“Polling booth”: a statutory booth for casting votes and for securing the secrecy of the ballot, usually comprising three walls and housing e.g. a list of the candidates included in the election and the candidate information needed in voting as well as a terminal for selecting a candidate and encrypting the ballot.

“Polling device”: a device at the disposal of the voter in the polling booth to select a candidate, adding a random code and possible check symbol to the candidate information of the candidate selected by the voter and generating from the candidate information of the candidate voted by the voter, using a known encryption method, a polling code which can be unequivocally associated with the candidate in question.

“Ballot paper”: a piece of paper or cardboard or like material, on which the voter writes the ciphered polling code of the candidate selected by him, which polling code is generated by a terminal, or, alternatively, a material on which the ciphered polling code generated by the terminal is printed.

“Polling station”: a physical location such as a room or vehicle provided by the postal service, for example, having the necessary voting equipment and electoral staff and in which the voting takes place.

“Voter”: a person eligible to vote who wants to cast a ballot.

“Register of eligible voters”: a register containing the names, personal data, and voting right information of all persons eligible to vote.

In a method according to the invention, a polling station is at first set up, including at least the equipment needed in voting and the election officials. The polling station may be opened e.g. in such a manner that an election official reports to the election system that he is present. This reporting can be done according to the invention e.g. through the use of a mobile communication device by sending to the election system the necessary data such as the number of the polling station and a password or other such code required to authenticate the official.

As the voter arrives at the polling station, his identity shall be verified, as decreed by law, based on an ID card or other such identification document having a photograph attached to it. After that the voter can enter the polling booth and select a candidate or option e.g. from a list on the wall or from the polling device using a mouse, touch-screen display, keyboard or other such medium.

The polling device in the polling booth generates, based on the candidate's or option number or other such candidate information, an encrypted polling code which may be printed out on the voter's ballot paper or, alternatively, the voter may write the code himself. Next, the voter takes the ballot paper, which contains the polling code, to an election official who uses his terminal to send the voter's personal identification information to the register of eligible voters in order to verify the voter's right to vote. After the verification, the official enters the polling code shown on the voter's ballot paper at his terminal and transmits it to the election data system where the polling code is decrypted and the vote corresponding to the polling code is recorded to the respective candidate.

Advantageous embodiments of the invention will be described below a little more closely, referring to the accompanying drawings in which

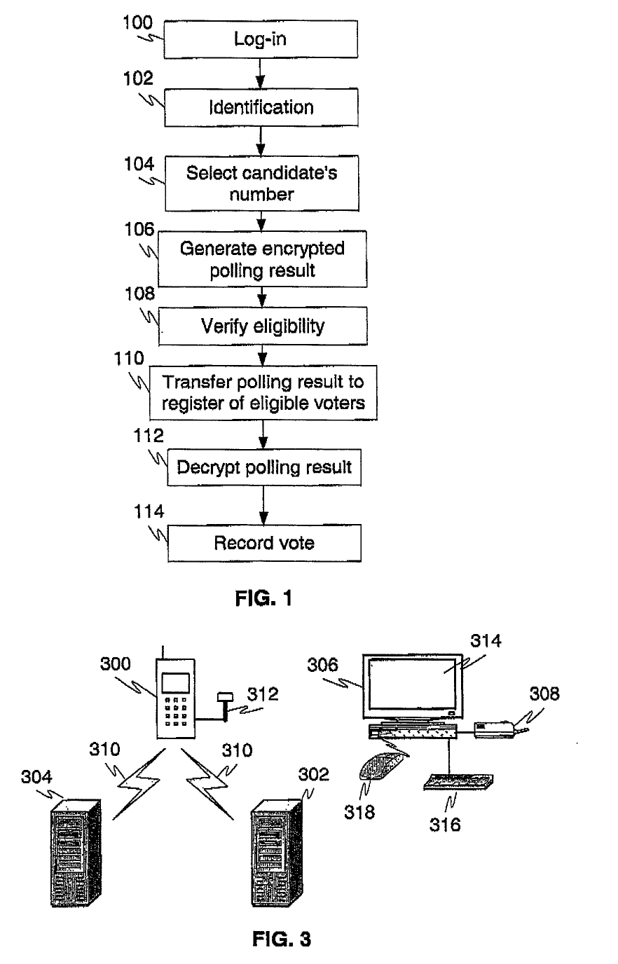

FIG. 1 shows a method according to the invention for voting,

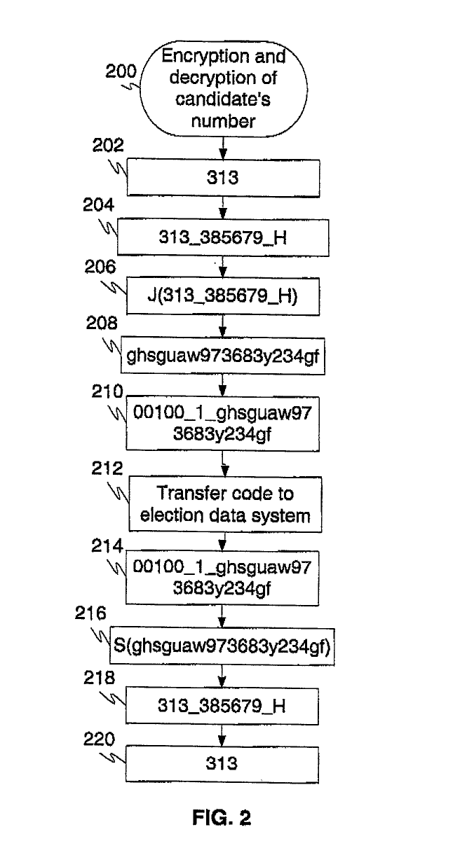

FIG. 2 shows a method according to the invention for encrypting and decrypting a polling code, and

FIG. 3 shows an arrangement according to the invention for voting.

FIG. 1 shows a method according to the invention for voting, where in step 100 an election official first logs in to the election data system. The official may log in to the election data system through his terminal such as a mobile communication device, for example. In the log-in, the official shall enter at his terminal the necessary data such as the number of the polling station and the password or other such code required to identify the official. The official may also sign these data at the terminal, using his digital signature. The election data system identifies and authenticates the election official and establishes a right for the official to send voting data to the election data system. The election official may also be requested by the election data system or by the register of eligible voters a log-in or digital signature in conjunction with each vote cast or with the verification of the voting right so that misuse of the official's terminal at the hands of unauthorized persons, for example, can be prevented. Alternatively, the official may be requested to report at certain intervals and if the official does not respond or responds using a wrong code, his right to access the election data system or the register of eligible voters can be canceled. That right can be reestablished when the official reports in the correct manner.

Upon arriving at the polling station the voter has to identify himself to the election official, step 102, using e.g. an ID card or other such identification document which has a photograph attached to it. At this stage the election official may give the ballot paper to the voter for writing the polling code on it, after which the voter enters a special polling booth according to the law. In step 104 the voter can select the number of a candidate or option from a list attached to the wall of the polling booth, or he may have already decided upon a candidate on the basis of advertisements, for example. Having selected a candidate's number the voter can enter the number at the voting device in the polling booth. Alternatively, the voter may select the number or other identifier of a candidate from the display of the voting device by means of a mouse, touch-screen display, keyboard or other such medium. The candidate information may also comprise the candidate's name or some other similar identifier.

In step 106 the candidate's number or other such piece of information is turned into an encrypted code by the polling device using e.g. known encryption methods such as the public key method. The code thus generated may comprise letters, numbers or special characters and it might be X567, for example. In accordance with the invention, the polling device adds a random number or sequence of characters to the candidate information prior to the encryption of the candidate information. Thus it is likely that the next voter who votes for the same candidate will get a different code, say X876. The code may be displayed on the display screen of the polling device so that the voter can write it on his ballot paper. Optionally the code may be printed out by a printer connected to the polling device in the polling booth when the voter inserts his ballot paper in the printer, for instance. The code generated may also be a bar code.

When the encrypted polling code has been generated and printed out, the polling device may display the name, number or other piece of information of the candidate to the voter so that the voter can make sure he voted the candidate he selected. Optionally the polling device may display the name, number or other piece of information of the candidate also at the stage where the voter selected a candidate by means of, say, a touch-screen display, and verify whether the voter really wants to vote for the candidate selected or whether he accidentally selected a wrong candidate. If the selection is as intended, the voter can e.g. press a “Continue” button, whereby the polling device takes the candidate information in question and generates the encrypted polling code. Alternatively, the voter may cancel the polling procedure.

Having received the polling code for the candidate selected, the voter takes the ballot paper, which now contains the code, to the election official and produces proof of his identity. In step 108, the eligibility of the voter is checked by the election official entering the ID code of the voter at his terminal and sending it to the register of eligible voters where the eligibility is verified and where it is recorded that the voter in question has now voted. Eligibility information may also be sent to the election official's terminal after the verification of eligibility whereby in a positive case the election official can in step 110 transfer the voter's polling code to the election data system through his terminal.

This method ensures that the polling code cannot be tied to the identity of the voter as the events can take place independently e.g. such that the eligibility of the voter can be verified at a different place than where the polling code is sent. Optionally, a separate connection may be set up for the verification of eligibility and for transferring the polling code even if the register of eligible voters and election data system were located at the same physical location.

In step 112 the encrypted polling code is decrypted in the election data system, and in step 114 the vote corresponding to the polling code is recorded to the candidate in question. Additionally in step 114 a message may be sent to the election official's terminal indicating that the vote was recorded successfully.

Alternatively, the encrypted polling code generated from the candidate selected by the voter and printed out on paper or similar material can be sent to the election data system via mail, e-mail, the Internet or as a facsimile.

FIG. 2 shows a method 200 according to the invention for encrypting and decrypting the ballot. When the voter has selected a candidate's number (say 313) in step 202, the polling device may in step 204 in accordance with the invention add to the candidate's or option number a random sequence, say 385679, and a check symbol corresponding to the random sequence, say the letter H. The check symbol may be generated using a simple remainder method, like that used for generating ID codes. The random sequence and candidate's number may be separated by a predetermined character such as an underscore or the like. Following the actions in step 204, the polling code may be e.g. 313_{—}385679_H.

In step 206 the polling device encrypts the polling code which comprises at least the candidate's or option number or other information with a random sequence and the corresponding check symbol attached thereto. The encryption may be done e.g. in accordance with the public key method, in which case at least the election system has got a public key (J) and a secret key (S) of its own. Also the polling device in the polling booth at the polling station may have public and secret keys of its own. Encryption is advantageously done by the polling device in the polling booth, using the public key J of the election system. After the encryption, in step 208, a polling code will have been generated from the candidate's number and the random sequence and the check symbol, such that from the polling code it is impossible to deduce the original candidate's number or option selected, without decrypting the code. The polling code may comprise e.g. letters, numbers or special characters and it may be e.g. ghsguaw973683y234gf or, alternatively, the polling code may comprise a bar code. In step 210 the polling device in the polling booth may add to the polling result, if necessary, a plain-language identification for the polling device and/or polling station (say, 00100_{—}1) after which the encrypted polling code and the identification can be printed out on the voter's ballot paper. Optionally, the election official or his terminal may add the identification for the terminal and/or polling station to the polling result in conjunction with the transmission of the polling code.

In step 212 the voter takes his ballot paper to the election official at the polling station who can check the identification of the terminal or polling station e.g. from the beginning of the polling code. Alternatively, if bar codes are used, the election official can use a bar code reader to read the bar code and thereby check the identification of the polling station or terminal. However, the election official cannot see from the polling result which candidate or option the voter voted. The polling code is transferred from the ballot paper to the election official's terminal advantageously by means of a bar code reader or by typing in the code. From the election official's terminal the polling code can be transmitted to the election data system e.g. as an SMS message.

In step 214 the polling code is received in the election data system. The polling station, election official's terminal or the polling device can be identified from the identification of the polling station, election official's terminal or polling device (say, 00100_{—}1). In step 214 the identification is removed from the polling result and in step 216 the polling code encrypted with the public key J of the election data system is decrypted using the secret key S of the election data system. After decryption, the polling code can be displayed in plain language, step 218. At that point the polling result still contains the candidate's number (313) and the random sequence (385679) and check symbol (H) added to the polling result by the polling device. In step 220, the check symbol and random sequence as well as the separators between the random sequence/check symbol and the candidate's number are removed from the polling result. In step 220 the candidate's number or some other piece of information about the candidate can be displayed in plain language and the vote can be recorded.

FIG. 3 shows an arrangement according to the invention for voting. The arrangement comprises an election official's terminal 300, election data system 302, register of eligible voters 304, and a polling device 306 in the polling booth with a printer 308 connected thereto.

The election official's terminal 300 may be e.g. a portable terminal such as a mobile communication device or a computer or digital TV. In particular the terminal 300 may be a mobile phone such as e.g. a GSM mobile phone. The terminal is typically connected to the election data system 302 and register of eligible voters 304 via a communications connection 310 the type of which depends on the terminal 300. Typically the terminal 300 comprises a means for transmitting the voter's ID code to the register of eligible voters 304 and means for transmitting the encrypted polling code to the election data system 302. Furthermore, the terminal may comprise a means 312 for reading a bar code on the ballot paper and means for reporting the presence of the election official to the election data system as well as a means for digitally signing a message to be transmitted.

The voter can select a candidate or option from a list posted on a wall of the polling booth, or from the polling device 306 in the polling booth. Typically the polling device 306 comprises a means for selecting a candidate. The medium used for the selection may be e.g. a mouse 318, keyboard 316, touch-screen display 314 or another similar apparatus that can be attached to the polling device 306 to select a candidate. The polling device further comprises a means for adding a random sequence and check symbol to the polling result and a means for encrypting the polling code comprised of the candidate's number or option and a random sequence/check symbol, using the public key method, for instance. Moreover, the polling device 306 typically comprises a means 314 for displaying the encrypted polling code to the voter or printing out the encrypted polling code on the voter's ballot paper by means of printer 308. The polling device typically also comprises a means 314 for displaying the candidate voted to the voter and a means for canceling the voting procedure. The voting procedure may be canceled by means of a keyboard 316 or mouse 318 or a prompt on the touch-screen display 314 of the polling device 306 or using some other such medium.

The register of eligible voters 304 comprises a means for receiving a voter's ID code sent from an election official's terminal 300 and for verifying the eligibility of the voter corresponding to the ID code. Typically the register of eligible voters 304 also comprises a means for sending a message concerning the eligibility of a given voter to an election official's terminal 300. Furthermore, the register of eligible voters 304 may comprise a means for identifying an election official's terminal 300 and a means for encrypting messages to be transmitted and decrypting messages received, using known encryption methods such as the public key method, for example. The register of eligible voters 304 may be integrated in the election data system 302.

The election data system 302 comprises a means for receiving and decrypting an encrypted polling code sent from an election official's terminal 300 and for recording the vote to the appropriate candidate. The election data system 302 may also comprise a means for identifying the terminal 300 of the election official who sent the polling code, and a means for identifying an election official logging in to the election data system. Furthermore, the election data system may comprise a means for sending to the election official's terminal 300 a message indicating a successful recording of the vote. In addition, the election data system may comprise a means for identifying and registering the polling station on the basis of a polling station code included in a polling result received.

Only a few embodiments of the arrangement according to the invention were described above. The principle according to the invention, as regards e.g. implementation details and field of application, may naturally be modified within the scope of the invention defined by the claims attached hereto.

In particular, the terminals may be any terminals that facilitate the use of the voting method according to the invention. Moreover, the polling code encryption method may be any known encryption method. Furthermore, the object of voting may be a person, option or an opinion put up as a candidate in an election or poll.

1. A voting method in which the voter selects a candidate using candidate information associated with the candidate, characterized in that the method comprises steps in which
an encrypted polling code is generated from the candidate information of the candidate selected by the voter,
the voter's encrypted polling code is transmitted to the election data system,
the encrypted polling code is decrypted in the election data system, and
the vote contained in the polling code is recorded to the respective candidate.

2. A method according to claim 1, characterized in that prior to encryption, a random character sequence is added to the candidate information, and said random character sequence is removed from the candidate information after decryption.

3. A method according to claim 1 or 2, characterized in that a check symbol is added to the candidate information.

4. A method according to any one of claims 1 to 3, characterized in that the candidate information is encrypted using a public key method (PKI).

5. A method according to any one of claims 1 to 4, characterized in that the encrypted polling code comprises numbers, letters and/or special characters.

6. A method according to any one of claims 1 to 5, characterized in that the encrypted polling code is a bar code.

7. A method according to any one of claims 1 to 6, characterized in that the data are transferred in SMS messages.

8. A method according to claim 1, characterized in that the eligibility of the voter is verified by sending the voter's ID code to the register of eligible voters, and an entry is made in the register indicating that the voter in question has used his vote.

9. A method according to any one of claims 1, 7 or 8, characterized in that an election official logs in to the election data system by entering a code at his terminal in order to obtain the right to send in information regarding a voting instance.

10. A voting arrangement, characterized in that the arrangement comprises a register of eligible voters and an election data system as well as
a means for generating an encrypted polling code from the candidate information of the candidate selected by the voter,
a means for transmitting the voter's encrypted polling code to the election data system,
a means for decrypting the encrypted polling code in the election data system, and
a means for recording the vote contained in the polling code to the respective candidate.

11. An arrangement according to claim 10, characterized in that the arrangement comprises a means for presenting the polling code as a bar code.

12. An arrangement according to claim 10, characterized in that the terminal is a mobile communication device.

13. An arrangement according to claim 10, characterized in that the arrangement comprises a means for verifying the eligibility of the voter from the register of eligible voters by sending the voter's ID code to the register of eligible voters, and a means for marking the voter's voting right used.

14. A polling device, characterized in that the device comprises
a means for inputting candidate information of a candidate selected by a voter,
a means for adding a random character sequence to the candidate information of a candidate selected by a voter, and
a means for decrypting an encrypted polling code.

15. A device according to claim 14, characterized in that the device comprises a means for presenting an encrypted polling code as bar code.

16. A device according to claim 14, characterized in that the device comprises a means for presenting an encrypted polling code as numbers, letters and/or special characters.

17. A device according to any one of claims 14 to 17, characterized in that the device comprises a means for printing out a polling code on the voter's ballot paper.

18. A device according to claim 14, characterized in that the device is a computer.
